(19) United States
(12) Patent Application Publication
(10) Pub. No.: US 2025/0139798 A1
(43) Pub. Date: May 1, 2025

(54) APPARATUS FOR TRAINING, INFERENCE AND METHOD THEREOF

(71) Applicants: Hyundai Motor Company, Seoul (KR); Kia Corporation, Seoul (KR)

(72) Inventors: Jin Sol Kim, Hwaseong-Si (KR); Jin Ho Park, Seoul (KR); Jang Yoon Kim, Seoul (KR)

(21) Appl. No.: 18/617,801

(22) Filed: Mar. 27, 2024

(30) Foreign Application Priority Data
Oct. 27, 2023 (KR) 10-2023-0145795

(51) Int. Cl. G06T 7/50; G06T 7/246

(52) U.S. Cl. CPC G06T 7/50; G06T 7/248; G06T 2207/20081

(57) ABSTRACT

The present disclosure relates to an apparatus for training and causing autonomous driving control of a vehicle. The apparatus may comprise at least one processor, and a memory storing instructions, when executed by the at least one processor, cause the apparatus to obtain, based on a depth map obtained from a cluster of points at a target time point, a depth distribution map, obtain, based on an input image that is associated with the target time point and that is applied to a monocular depth estimation (MDE) model, a depth estimation map, update, based on a loss function group applied to the MDE model, a plurality of weights included in the MDE model, wherein the loss function group may comprise a first loss function that is obtained based on the depth distribution map and the depth estimation map, and output a signal indicating the updated plurality of weights.

### CROSS-REFERENCE TO RELATED APPLICATION

This application claims the benefit of priority to Korean Patent Application No. 10-2023-0145795, filed in the Korean Intellectual Property Office on Oct. 27, 2023, the entire contents of which are incorporated herein by reference.

### TECHNICAL FIELD

The present disclosure relates to a training apparatus, an inference apparatus, and a training method, and more specifically, relates to a technology for training a monocular depth estimation model.

### BACKGROUND

With the development of a deep neural network-based computer vision technology in an autonomous driving technology, various artificial intelligence models such as object detection, semantic segmentation, depth map estimation, and lane detection are being studied.

In particular, the output of the monocular depth estimation model for autonomous driving may be used to recognize a drivable range of an autonomous driving vehicle. However, it is difficult to quantitatively obtain uncertainty about the output of a monocular depth estimation model.

For example, in a regression task of estimating a specific value, a Bayesian and ensemble method of using several outputs for one input may be used to quantitatively obtain the uncertainty. However, it is inefficient to use the method in a vehicle that being actually driving. Moreover, in a classification task of obtaining a specific class, the uncertainty may be obtained by quantitatively using entropy. However, the number of cases in each of which depth information is capable being expressed may be reduced.

To solve these issues, there is a need to develop a technology for training a monocular depth estimation model for estimating a depth in units of pixel and estimating the uncertainty of the depth in a vehicle being actually driving.

### SUMMARY

According to the present disclosure, an apparatus may comprise at least one processor, and a memory storing instructions, when executed by the at least one processor, cause the apparatus to obtain, based on a depth map obtained from a cluster of points at a target time point, a depth distribution map, obtain, based on an input image that is associated with the target time point and that is applied to a monocular depth estimation (MDE) model, a depth estimation map, update, based on a loss function group applied to the MDE model, a plurality of weights included in the MDE model, wherein the loss function group may comprise a first loss function that is obtained based on the depth distribution map and the depth estimation map, and output a signal indicating the updated plurality of weights.

The apparatus, wherein the instructions, when executed by the at least one processor, further cause the apparatus to cause, based on an updated MDE model, autonomous driving control of a vehicle, wherein the updated MDE model is updated based on the updated plurality of weights.

The apparatus, wherein the instructions, when executed by the at least one processor, further cause the apparatus to obtain the depth map by extracting pieces of depth information from the cluster of points, wherein the pieces of depth information are associated with a plurality of pixels included in the depth map, obtain a depth tensor by extending a channel of the depth map, wherein the channel of the depth map is extended by a first condition based on the pieces of depth information, and obtain, based on the depth tensor, the depth distribution map.

The apparatus, wherein the instructions, when executed by the at least one processor, further cause the apparatus to determine, based on sensing information obtained by a sensor, a minimum discretization value and a maximum discretization value that are associated with channels included in an individual pixel of the depth tensor, and determine a discretization value of each of the channels, wherein the discretization value of each of the channels is determined based on an index of each of the channels included in the individual pixel, the minimum discretization value, the maximum discretization value, and a number of the channels.

The apparatus, wherein the instructions, when executed by the at least one processor, further cause the apparatus to determine, based on a discretization value of an N-th channel of an individual pixel of the depth tensor and a discretization value of an (N+1)-th channel of the individual pixel following the N-th channel, a ratio of the discretization value of the N-th channel and the discretization value of the (N+1)-th channel as a representative discretization value of the N-th channel, and wherein N is a natural number and smaller than or equal to a total number of channels of the depth tensor.

The apparatus, wherein the depth distribution map may comprise pixels, and wherein a representative discretization value of a pixel of the pixels is associated with channels included in the pixel of pixels of the depth tensor, and wherein a sum of probabilities may comprise probabilities that satisfy a second condition, wherein the sum of probabilities is associated with channels included in each of the pixels of the depth tensor.

The apparatus, wherein the instructions, when executed by the at least one processor, further cause the apparatus to obtain a first estimation depth of a first pixel among a plurality of pixels included in the depth distribution map, obtain a second estimation depth of a second pixel among a plurality of pixels included in the depth estimation map, wherein the second pixel is related to a location corresponding to the first pixel, determine, based on the first estimation depth and the second estimation depth, the first loss function, and update, based on the determined first loss function, the plurality of weights included in the MDE model for obtaining the second estimation depth.

The apparatus, wherein the instructions, when executed by the at least one processor, further cause the apparatus to determine, based on the first estimation depth satisfying a third condition, a difference between the first estimation depth and the second estimation depth as the first loss function, or skip updating, based on the first estimation depth not satisfying the third condition, the plurality of weights included in the MDE model for obtaining the second estimation depth.

The apparatus, wherein the instructions, when executed by the at least one processor, further cause the apparatus to obtain pose change information by applying an input image at a time point different from the target time point and an input image at the target time point to a pose estimation model, obtain a first cluster of points at the target time point by applying an inverse of an intrinsic parameter related to a sensor to the depth estimation map, obtain a second cluster of points at a time point different from the target time point by applying the pose change information to the first cluster of points, and determine, based on the second cluster of points, a second loss function different from the first loss function, and wherein the loss function group may further comprise the second loss function.

The apparatus, wherein the instructions, when executed by the at least one processor, further cause the apparatus to obtain a reconstruction image by applying the intrinsic parameter to the second cluster of points, and determine, based on the input image and the reconstruction image, the second loss function.

The apparatus, wherein the instructions, when executed by the at least one processor, further cause the apparatus to obtain a first factor indicating a mean value associated with channels of a target pixel among pixels included in the depth estimation map and a second factor indicating a standard deviation value associated with the channels of the target pixel, and obtain, based on the first factor and the second factor, a relative standard deviation value indicating uncertainty of the target pixel.

According to the present disclosure, an apparatus may comprise at least one processor, and a memory storing instructions, when executed by the at least one processor, cause the apparatus to obtain a target image for testing, obtain a target depth estimation map by applying the target image to a monocular depth estimation model including updated weights, wherein target depth estimation map may comprise an estimation depth of each of a plurality of pixels included in the target image, obtain a target uncertainty map, wherein the target uncertainty map may comprise a relative standard deviation value of each of a plurality of estimation depths included in the target depth estimation map, and output a signal indicating the target uncertainty map.

According to the present disclosure, a method performed by a processor, the method may comprise obtaining, based on a depth map obtained from a cluster of points at a target time point, a depth distribution map, obtaining a depth estimation map by applying an input image that is associated with the target time point to a monocular depth estimation (MDE) model, updating, based on a loss function group applied to the MDE model, a plurality of weights included in the MDE model, wherein the loss function group may comprise a first loss function that is obtained based on the depth distribution map and the depth estimation map, and outputting a signal indicating the updated plurality of weights.

The method, wherein the obtaining the depth distribution map may comprise obtaining the depth map by extracting pieces of depth information from the cluster of points, wherein the pieces of depth information are associated with a plurality of pixels included in the depth map, obtaining a depth tensor by extending a channel of the depth map, wherein the channel of the depth map is extended by a first condition based on the pieces of depth information, and obtaining, based on the depth tensor, the depth distribution map.

The method, wherein the obtaining the depth distribution map may comprise determining, based on sensing information obtained by a sensor, a minimum discretization value and a maximum discretization value that are associated with channels included in an individual pixel of the depth tensor, and determining a discretization value of each of the channels, wherein the discretization value of each of the channels is determined based on an index of each of the channels included in the individual pixel, the minimum discretization value, the maximum discretization value, and a number of the channels.

The method, wherein the obtaining the depth distribution map may comprise determining, based on a discretization value of an N-th channel of an individual pixel and a discretization value of an (N+1)-th channel of the individual pixel following the N-th channel, a ratio of the discretization value of the N-th channel and the discretization value of the (N+1)-th channel as a representative discretization value of the N-th channel, and wherein N is a natural number and smaller than or equal to a total number of channels of the depth tensor, wherein the depth distribution map may comprise pixels, and wherein a representative discretization value of a pixel of the pixels is associated with channels included in the pixel of pixels of the depth tensor, and wherein a sum of probabilities may comprise probabilities that satisfy a second condition, wherein the sum of probabilities is associated with channels included in each of the pixels of the depth tensor.

The method, wherein the updating the plurality of weights included in the MDE model may comprise obtaining a first estimation depth of a first pixel among a plurality of in the depth distribution map, obtaining a pixels second estimation depth of a second pixel among a plurality of pixels included in the depth estimation map, wherein the second pixel is related to a location corresponding to the first pixel, determining, based on the first estimation depth and the second estimation depth, the first loss function, and updating, based on the determined first loss function, the plurality of weights included in the MDE model for obtaining the second estimation depth.

The method, wherein the updating the plurality of weights included in the MDE model may comprise determining, based on the first estimation depth satisfying a third condition, a difference between the first estimation depth and the second estimation depth as the first loss function, or skipping, based on the first estimation depth not satisfying the third condition, updating the plurality of weights included in the MDE model for obtaining the second estimation depth.

The method, may further comprise obtaining pose change information by applying an input image at a time point different from the target time point and an input image at the target time point to a pose estimation model, obtaining a first cluster of points at the target time point by applying an inverse of an intrinsic parameter related to a sensor to the depth estimation map, obtaining a second cluster of points at a time point different from the target time point by applying the pose change information to the first cluster of points, and determining, based on the second cluster of points, a second loss function different from the first loss function, and wherein the loss function group may further comprise the second loss function.

The method, wherein the determining the second loss function may comprise obtaining a reconstruction image by applying the intrinsic parameter to the second cluster of points, and determining, based on the input image and the reconstruction image, the second loss function.

The method, may further comprise obtaining a first factor indicating a mean value associated with channels of a target pixel among pixels included in the depth estimation map and a second factor indicating a standard deviation value associated with the channels of the target pixel, and obtaining, based on the first factor and the second factor, a relative standard deviation value indicating uncertainty of the target pixel.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a training apparatus for a monocular depth estimation model, according to an example of the present disclosure;

FIG. 2 shows an example of a flow chart for describing a method of training a monocular depth estimation model, according to an example of the present disclosure;

FIG. 3 shows an example of a process of training a monocular depth estimation model by obtaining a first loss function and a second loss function in a training apparatus, according to an example of the present disclosure;

FIG. 4 shows an example of a method of obtaining a depth distribution map based on a depth map in a training apparatus, according to an example of the present disclosure;

FIG. 5 shows an example of generating a depth distribution map in a training apparatus, according to an example of the present disclosure;

FIG. 6 shows an example of a process of training a monocular depth estimation model by obtaining a first loss function and a second loss function in a training apparatus, according to an example of the present disclosure;

FIG. 7 shows an example of a target image, an estimation depth of each of pixels included in an input image, and uncertainty of each of the pixels included in the input image in an inference apparatus, according to an example of the present disclosure;

FIG. 8 shows an example of a correlation between an estimation depth and RSD in a training apparatus, according to an example of the present disclosure; and

FIG. 9 shows an example of a computing system related to a training apparatus or training method, according to an example of the present disclosure.

With regard to description of drawings, the same or similar components will be marked by the same or similar reference signs.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted if they may make subject matters of the present disclosure unnecessarily obscure. Hereinafter, various examples of the present disclosure may be described with reference to accompanying drawings. Accordingly, those of ordinary skill in the art will recognize that modification, equivalent, and/or alternative on the various examples described herein may be variously made without departing from the scope and spirit of the present disclosure. With regard to description of drawings, similar components may be marked by similar reference numerals.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein. For example, the terms, such as “first”, “second”, and the like used herein may refer components of various examples of the present to various disclosure, but do not limit the elements. For example, “a first user device” and “a second user device” may indicate different user devices regardless of the order or priority thereof. For example, without departing the scope of the present disclosure, a first complement may be referred to as a second component, and similarly, a second complement may be referred to as a first complement.

In this specification, the expressions “have”, “may have”, “include” and “comprise”, or “may include” and “may comprise” used herein indicate existence of corresponding features (e.g., elements such as numeric values, functions, operations, or but do not exclude presence of additional features.

It will be understood that if an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, if an element (e.g., a first element) is referred to as being “directly coupled with/to” or “directly connected to” another element (e.g., a second element), it should be understood that there is no intervening element (e.g., a third element).

According to the situation, the expression “configured to” used herein may be used as, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device. The terms used in the specification are only used to describe a specific example and are not intended to limit the scope of the present disclosure. The terms of a singular form may include plural forms unless otherwise specified. All the terms used herein, which include technical or scientific terms, may include the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various examples of the present disclosure. In some cases, even if terms are terms which are defined in the specification, they may not be interpreted to exclude examples of the present disclosure.

In the present disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Moreover, in describing a component of an example of the present disclosure, the expressions at least one of “A or B”, “at least one of A and B”, “at least one of A or B”, “A, B, or C”, “at least one of A, B, and C”, or “at least one of A, B, or C”, or any combination thereof may include any and all combinations of one or more of the associated listed items. In particular, expressions “at least one of A, B, or C, or any combination thereof” may include A, B, or C, or any combination thereof such as AB, ABC, or the like.

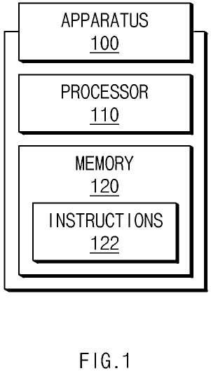

Hereinafter, various examples of the present disclosure will be described in detail with reference to FIGS. 1 to 9.

FIG. 1 shows an example of a training apparatus for a monocular depth estimation model, according to an example of the present disclosure.

According to an example, an apparatus 100 may include a processor 110 and a memory 120 including instructions 122.

The apparatus 100 may indicate a device that trains a monocular depth estimation model. For example, the apparatus 100 may update a plurality of weights included in the monocular depth estimation model by applying a loss function group to the monocular depth estimation model. In other words, the apparatus 100 may train the monocular depth estimation model by updating the plurality of weights included in the monocular depth estimation model.

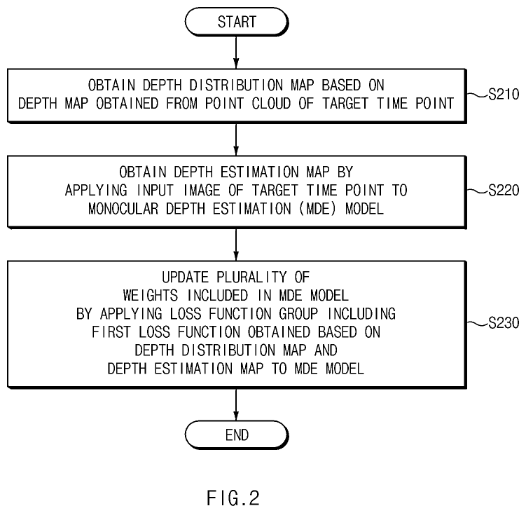

The monocular depth estimation model may be a network of a U-net structure including an encoder and a decoder. Here, the encoder may be a ResNet model, and the decoder may be a model that converts a sigmoid output into a depth estimation map. In particular, the apparatus may obtain the depth estimation map from the decoder by applying an input image of a target time point to the encoder of the monocular depth estimation model. A detailed description of the monocular depth estimation model is described later in FIG. 2 below.

The loss function group may include a first loss function and a second loss function. The apparatus 100 may update the plurality of weights included in the monocular depth estimation model by applying each of the first loss function and the second loss function to the monocular depth estimation model.

The first loss function may be obtained based on a depth distribution map and a depth estimation map.

The depth distribution map may indicate a set of depth information (e.g., information about a distance between an object and a lidar) indicating three-dimensional (3D) distance information of an object and a background, which are present in an image obtained as the lidar obtains an actual scene including a predetermined area based on a location of a vehicle. In detail, the depth distribution map may include a plurality of pixels obtained by dividing the object and the background, which are present in the above-described image, by using a grid with a predetermined size. The depth distribution map may include depth information of each of the plurality of pixels. In particular, the depth distribution map may include a probability distribution of depth information of each of the plurality of pixels. Accordingly, the depth distribution map may indicate a map including the probability distribution of depth information of each of the plurality of pixels in an image where an actual scene is displayed by using the plurality of pixels.

The depth estimation map may indicate a set of depth information (e.g., information about a distance between an object and a camera including an image sensor) obtained by a monocular depth estimation model of 3D distance information of an object and a background, which are present in an image obtained as a mono-camera (or a monocular camera) captures an actual scene including a predetermined area based on a location of the vehicle. In detail, the depth estimation map may include a plurality of pixels obtained by dividing the object and the background, which are present in the above-described image, by using a grid with a predetermined size. The depth estimation map may include depth information of each of the plurality of pixels obtained by a monocular depth estimation model.

Accordingly, for convenience of description in this specification, it mainly described that the depth is distribution map may include depth information of the image obtained by the lidar, and the depth estimation map may include depth information obtained by applying an image obtained by a mono-camera to a monocular depth estimation model.

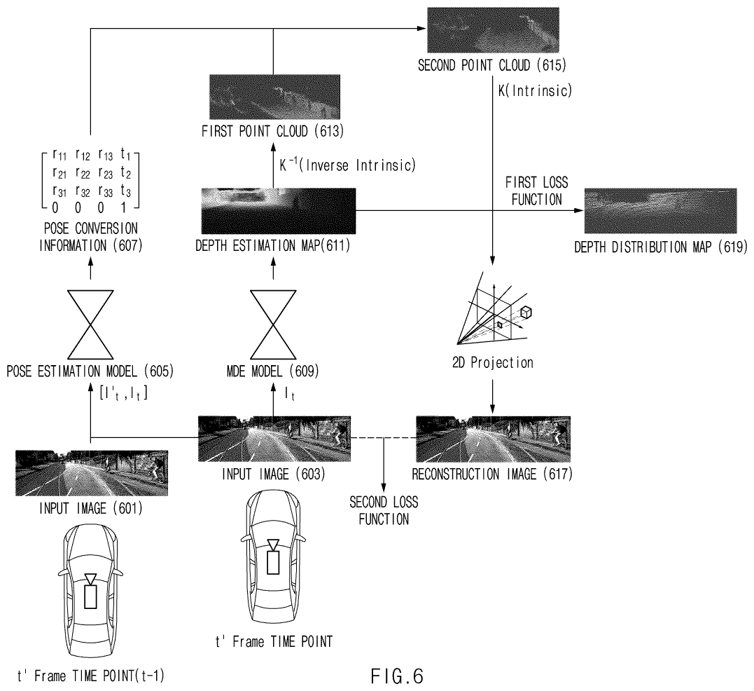

A method in which the apparatus 100 determines a first loss function is as follows. For example, the apparatus 100 may obtain a depth distribution map based on a depth map obtained from a point cloud of a target time point. Moreover, the apparatus 100 may obtain a depth estimation map by applying the input image of the target time point to a monocular depth estimation model. The apparatus 100 may determine a first loss function based on the depth distribution map and the depth estimation map. The detailed method in which the apparatus 100 determines the first loss function is described later in FIG. 6 below.

The second loss function may be obtained based on a reconstruction image and the input image of the target time point.

The input image of the target time point may be generated by an image sensor at the target time point. An input image of a time point different from the target time point may be generated by an image sensor at a time point different from the target time point. In this case, the time point different from the target time point may be at least one time point of the other time points, which exclude the target time point, from among time points within a threshold time interval based on the target time point.

A method in which the apparatus 100 determines a second loss function is as follows. For example, the apparatus 100 may obtain pose change information by applying an input image of a time point different from the target time point, and an input image of the target time point to a pose estimation model. The apparatus 100 may obtain a first point cloud of the target time point by applying the inverse of an intrinsic parameter related to the lidar to the depth estimation map. The apparatus 100 may obtain a second point cloud of a time point different from the target time point by applying the pose change information to the first point cloud. Finally, the apparatus 100 may determine a second loss function different from the first loss function based on the second point cloud. The detailed method in which the apparatus 100 determines the second loss function is described later in FIG. 6 below.

The pose estimation model may generate the pose change information corresponding to a pose change between the input image of the target time point and the input image of a time point different from the target time point. For example, the pose estimation model may generate the pose change information based on a first pose of the target time point of an image sensor and a second pose of a time point different from the target time point.

The pose change information may be information indicating a relationship between a camera pose of the target time point and a camera pose of a time point different from the target time point, and may be information corresponding to a rotation and translation matrix of an object.

The processor 110 may execute software and may control at least one other component (e.g., a hardware or software component) connected to the processor 110. The processor 110 may also perform various data processing or operations. For example, the processor 110 may store the depth distribution map, the depth estimation map, and the loss function group in the memory 120. For reference, the processor 110 may perform some or all operations performed by the apparatus 100. Therefore, for convenience of description in this specification, an operation performed by the apparatus 100 is mainly described as an operation performed by the processor 110.

Furthermore, for convenience of description in this specification, the processor 110 is mainly described as a single processor, but is not limited thereto. For example, the apparatus 100 may include at least one processor. The at least one processor may perform some or all operations related to training of the monocular depth estimation model.

The memory 120 may temporarily and/or permanently store various pieces of data and/or information to perform training of the monocular depth estimation model. For example, the memory 120 may store the depth distribution map, the depth estimation map, and the loss function group.

FIG. 2 shows an example of a flow chart for describing a method of training a monocular depth estimation model, according to an example of the present disclosure.

In S210, an apparatus (e.g., the apparatus 100 in FIG. 1) may obtain a depth distribution map based on a depth map obtained from a point cloud of a target time point.

The point cloud may be collected by a lidar or an RGB-D sensor. The point cloud may include a set of points obtained by calculating distance information per light/signal of an object measured by the lidar or the RGB-D sensor. Unlike a two-dimensional (2D) image, the point cloud may include information in a depth direction (e.g., z-axis), and thus the point cloud may be expressed in three dimensions.

The depth map may represent an image created by extracting only information in the depth direction from the point cloud. For example, the depth map may include pixels in each of which information (e.g., x-axis) in a horizontal direction and information (e.g., y-axis) in a vertical direction are omitted from each of the pixels included in the point cloud.

In S220, the apparatus may obtain a depth estimation map by applying the input image of the target time point to a monocular depth estimation model.

The monocular depth estimation model may include a plurality of layers, and each layer may include a plurality of nodes. The node may include a node value determined based on an activation function. A node on any layer may be connected to a node on another layer (e.g., another node) through a link (e.g., a connection edge) with a connection weight. The node value of a node may be propagated to other nodes through the link. In an inference operation of the monocular depth estimation model, node values may be forward propagated from the previous layer to the next layer.

For example, the forward propagation operation in the monocular depth estimation model may indicate an operation of propagating node values based on input data in a direction from an input layer of the monocular depth estimation model to an output layer of the monocular depth estimation model. In other words, the node value of the corresponding node may be propagated (e.g., forward propagated) to a node (e.g., the next node) of the next layer connected through the node and the connection edge. For example, the node may receive a value weighted by a connection weight from the previous node (e.g., a plurality of nodes) connected through the connection edge.

The node value of a node may be determined based on applying an activation function (e.g., a sigmoid function) to the sum (e.g., weighted sum) of weighted values received from previous nodes. For example, a parameter of a neural network may include the connection weight described above. The parameters of the neural network may be updated such that a value of a loss function (e.g., a first loss function and a second loss function) described later changes in a targeted direction (e.g., a direction in which a loss is minimized).

The monocular depth estimation model may indicate a model capable of being trained through machine learning, and may be a machine learning model that outputs a training output (e.g., a depth estimation map) from a training input (e.g., an input image).

For example, the learning algorithm may include supervised learning, unsupervised learning, semi-supervised learning, or reinforcement learning, but may not be limited to the above example. However, for convenience of description in this specification, a training algorithm of the monocular depth estimation model is mainly described as semi-supervised learning.

The monocular depth estimation model may include a plurality of artificial neural network layers. The artificial neural network may be one of a deep neural network (DNN), a convolutional neural (CNN), network U-Net for image segmentation (U-net), a recurrent neural network (RNN), a restricted Boltzmann machine (RBM), a deep belief network (DBN), a bidirectional recurrent deep neural network (BRDNN), or a deep Q-network, or at least one combination among combinations thereof, but may not be limited to the above-described example. However, for convenience of description in this specification, the monocular depth estimation model is mainly described as a network of U-net structure, and may be a model in which an encoder is a ResNet model, and the decoder is a model that converts a sigmoid output into a depth estimation map.

The U-Net, which is a monocular depth estimation model used by the apparatus, may be composed of an encoder, a decoder, and a connection thereof. The encoder generally may extract a hierarchical structure of an image feature map from low complexity to high complexity. On the other hand, the decoder may convert a feature and may reconstruct an output from low resolution to high resolution.

The monocular depth estimation model may include a convolution layer (Conv) that performs a linear transform operation, a batch normalization layer (BN) that performs a normalization operation, a rectified linear unit (ReLU) layer that performs a nonlinear function operation, and a channel concatenation layer or channel sum layer that combines outputs of a plurality of layers.

The monocular depth estimation model may be trained to output a training output from a training input. The monocular depth estimation model during training may generate a temporary output in response to the training input, and may be trained such that the loss between the temporary output and the training output (e.g., a training target) is minimized. During a training process, a parameter (e.g., a connection weight between nodes/layers in a neural network) of the machine learning model may be updated depending on the loss. For example, this training may be performed by the apparatus itself where the training of the monocular depth estimation model is performed, and may be performed through a separate server. The monocular depth estimation model in which training is completed may be stored in a memory (e.g., the memory 120 in FIG. 1).

In S230, the apparatus may update a plurality of weights included in the monocular depth estimation model by applying a loss function group including the first loss function obtained based on the depth distribution map and the depth estimation map to the monocular depth estimation model. However, a method of training the monocular depth estimation model is not limited thereto. As described above in FIG. 1, the apparatus may train the monocular depth estimation model based on the loss function group including the first loss function and the second loss function.

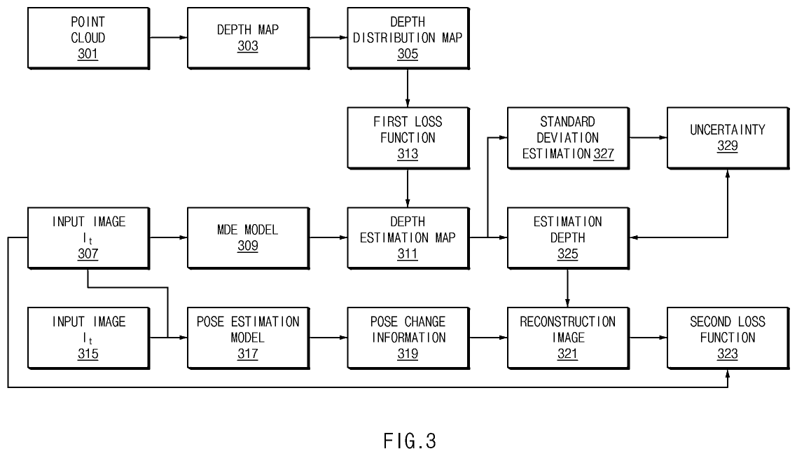

FIG. 3 shows an example of a process of training a monocular depth estimation model by obtaining a first loss function and a second loss function in a training apparatus, according to an example of the present disclosure.

An apparatus (e.g., the apparatus 100 in FIG. 1) may obtain a depth distribution map 305 based on a depth map 303 obtained from a point cloud 301 of a target time point. The apparatus may obtain a depth estimation map 311 by applying an input image 307 of the target time point to a monocular depth estimation model 309. The apparatus may obtain a first loss function 313 based on the depth distribution map 305 and the depth estimation map 311.

The apparatus may obtain pose change information 319 by applying an input image 315 of a time point different from the target time point, and the input image 307 of the target time point to a pose estimation model 317. The apparatus may obtain a reconstruction image 321 based on the pose change information 319. The apparatus may obtain a second loss function 323 based on the obtained reconstruction image 321 and the input image 307 of the target time point. A detailed description of obtaining the reconstruction image 321 is described later in FIG. 6 below.

The input image 315 of a time point different from the target time point and the input image 307 of the target time point may be obtained from an image frame obtained while the vehicle is driving. For example, the input image 315 of a time point different from the target time point may indicate an image obtained at a location where the vehicle is driving at a time point t′ different from the target time point. Similarly, the input image 307 of the target time point may indicate an image obtained at a location where the vehicle is driving at a target time point t (i.e., a time point subsequent to time point t′). Accordingly, the apparatus may obtain the pose change information 319 in a form of a matrix including information about pose changes of objects included in temporally continuous images, by applying the input image 307 and the input image 315 to the pose estimation model 317.

The apparatus may update (i.e., training the monocular depth estimation model 309) a plurality of weights included in the monocular depth estimation model 309 by applying the loss function group, including the first loss function 313 and the second loss function 323, to the monocular depth estimation model 309.

The apparatus may obtain uncertainty 329 of each of a plurality of pixels, which are included in the depth estimation map, based on the depth estimation map 311 obtained from the trained monocular depth estimation model 309. For example, the apparatus may obtain an estimation depth 325 of each of a plurality of pixels included in the depth estimation map 311.

Here, the estimation depth 325 may indicate distance information of an object (e.g., it may indicate a part of an object) included in a target pixel. For example, pixel A of the depth estimation map 311 may include an estimation depth with a value of ‘a’, and pixel B of the depth estimation map 311 may include an estimation depth with a value of ‘b’.

In addition or alternative to the estimation depth of the target pixel, the apparatus may obtain the average of channels of the target pixel and the standard deviation of the channels through standard estimation deviation 327. The apparatus may obtain the uncertainty 329 of the target pixel based on the average of the channels of the target pixel and the standard deviation of the channels. A detailed description thereof is described later in FIG. 6 below.

As described above, the apparatus may use the first loss function 313 and the second loss function 323 to train the monocular depth estimation model 309. Furthermore, the apparatus may obtain the uncertainty 329 of the target pixel corresponding to the estimation depth 325 based on the estimation depth 325 obtained from the monocular depth estimation model 309.

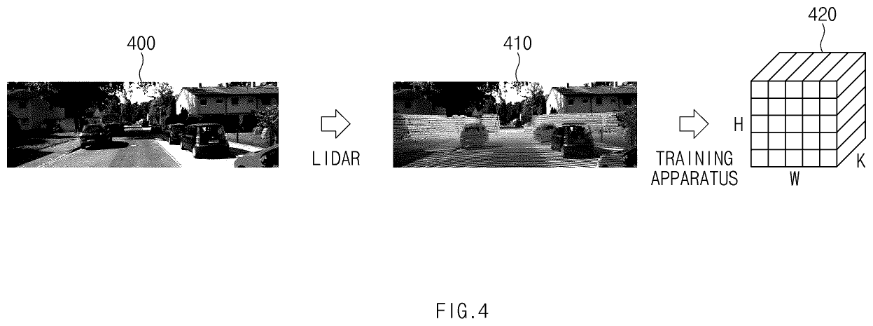

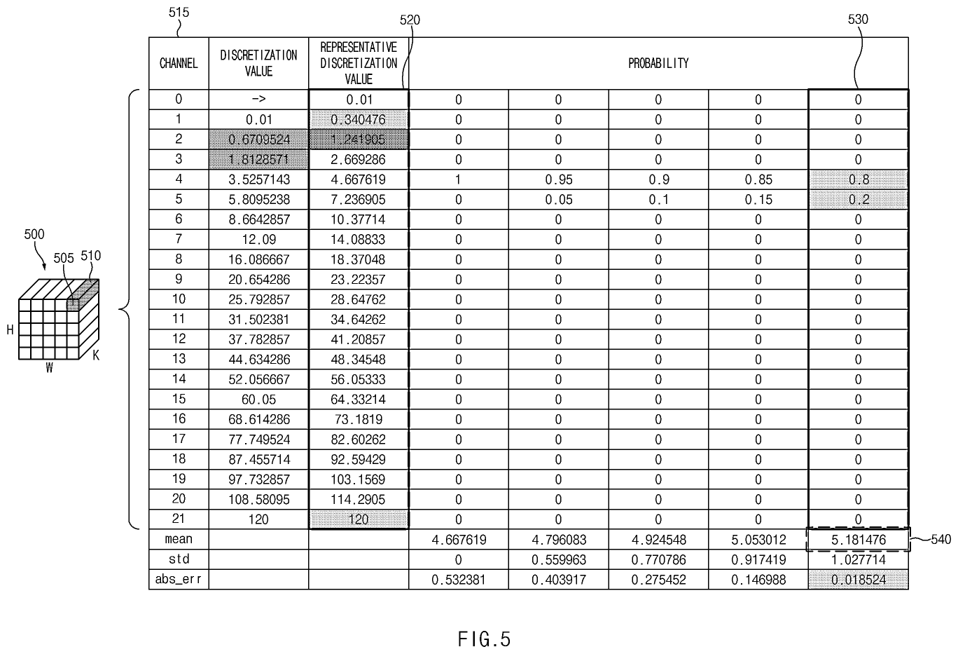

If the apparatus does not perform a process (hereinafter referred to as a “proposal process”) of obtaining the depth distribution map 305 from the point cloud 301, which is described later in FIGS. 4 and 5, the performance of the monocular depth estimation model 309 outputting the depth estimation map 311 and the uncertainty 329 may be degraded. For example, when obtaining only the one depth estimation map 311 from the monocular depth estimation model 309, the apparatus may train the monocular depth estimation model 309 without performing the proposal process. In this case, the performance of the monocular depth estimation model 309 may not be degraded. On the other hand, when the apparatus obtains the uncertainty 329 of the target pixel in addition or alternative to the depth estimation map 311 from the monocular depth estimation model 309, the performance of the monocular depth estimation model 309 may be degraded if the apparatus does not perform the proposal process. Accordingly, below, a method of training the monocular depth estimation model 309 is described later through a detailed description of the proposal process with reference to FIGS. 4 and 5.

FIG. 4 shows an example of a method of obtaining a depth distribution map based on a depth map in a training apparatus, according to an example of the present disclosure.

An apparatus (e.g., the apparatus 100 in FIG. 1) may obtain a cluster of points (e.g., a point cloud 410) from a scene 400 by a lidar. The apparatus may obtain a depth map by extracting pieces of depth information from the point cloud 410. For reference, as described above in FIG. 1, the depth map may indicate a 2D image created by extracting only information in a depth direction from the point cloud 410.

The apparatus may obtain a three dimensional (3D) representation from a two dimensional (2D) image (e.g., a depth tensor 420) by expanding a learned feature of input data (e.g., a channel of the depth map, a single-layer 2D array within a data structure containing information about a depth at each pixel, etc.) by a predetermined first condition based on each of a plurality of pixels included in the depth map. In other words, the depth tensor 420 may indicate a tensor including probability values as many as the number of channels, which corresponds to an estimation depth of each pixel included in the depth map being a 2D image. Referring to FIG. 4, an example in which the number of channels is ‘K’ is described.

Afterward, the apparatus may obtain a depth distribution map for obtaining a first loss function based on the depth tensor 420. A method of obtaining a depth distribution map from the depth tensor 420 is described later in FIG. 5 below.

FIG. 5 shows an example of generating a depth distribution map in a training according to an example of the present disclosure.

Referring to FIG. 5, a set 510 including probabilities corresponding to an estimation depth included in a target pixel 505 may be mainly described focusing on the target pixel 505 among a depth tensor 500. Moreover, the depth of an actual object of the target pixel 505 is described as 5.2 m.

A table 515 may include a discretization value (e.g., a threshold or interval used to bin continuous data into discrete buckets, a step size or an incremental value, a scale factor used to map floating-point numbers to integers, etc.), a representative discretization value, and probabilities of each of a plurality of channels included in set 510. For example, the apparatus (e.g., the apparatus 100 in FIG. 1) may expand the channel as many as the number corresponding to a first condition (e.g., 22 channel conditions) by using the depth information of each of pixels based on the plurality of pixels included in the depth map. The set 510 may include probability values respectively corresponding to channels as the estimation depth of the target pixel is expanded to 22 channels.

The apparatus may determine a first discretization value (e.g., a minimum discretization value or a relatively small discretization value) and a second discretization value (e.g., a maximum discretization value or a discretization value greater than the first discretization value) based on a sensor (e.g., a lidar) (i.e., expanding the condition of 22 channels based on a lidar spec) to determine the discretization value of each of the channels included in each individual pixel or the target pixel of the depth tensor. For example, referring to FIG. 5, the min discretization value is 0.01 and the max discretization value is 120.

The apparatus may determine a discretization value of each of the channels included in each individual pixel or the target pixel 505 based on an index (e.g., channel 0, channel 1, channel 2, . . . , channel 21), a min discretization value (e.g., 0.01), a max discretization value (e.g., 120), and the number of channels (e.g., a first condition of 22) of each of the channels included in the individual pixel or the target pixel 505.

A method in which the apparatus determines the discretization value of each channel may be expressed by Equations 1 to 3 below.

$${d}_{i} = {d}_{min} + ( {d}_{max} - {d}_{min} ) \times i / {n}_{bins} \qquad [ Equation 1 ]$$

Here, Equation 1 may mean uniform discretization. dₘᵢₙ may denote a min discretization value; dₘₐₓ may denote a max discretization value; i may denote a channel index; and n_{bins} may denote the number of channels, which is the number of targets determined by discretization values.

$${d}_{i} = exp ( log ( {d}_{min} ) + \frac{log ( \frac{{d}_{max}}{{d}_{min}} ) \times i}{{n}_{bins}} \qquad [ Equation 2 ]$$

Here, Equation 2 may mean spacing increasing discretization. dₘᵢₙ, dₘₐₓ, i, and n_{bins} may be the same as those described in Equation 1.

$${d}_{i} = {d}_{min} + \frac{{d}_{max} - {d}_{min}}{{n}_{bins} ( {n}_{bins} + 1 )} \times i \times ( i + 1 ) \qquad [ Equation 3 ]$$

Here, Equation 3 may mean linear increasing discretization. dₘᵢₙ, dₘₐₓ, i, and n_{bins} may be the same as those described in Equation 1 and Equation 2.

For reference, for convenience of explanation in this specification, it is mainly described that the apparatus determines the discretization values of the channels based on the linear increase discretization of Equation 3. Accordingly, referring to the discretization values in a table 515, the discretization values in the table 515 may include values, which are obtained by determining the discretization value of each channel included in the individual pixel, by determining the index, the min discretization value, the max discretization value, and the number of channels according to the linear increasing discretization in Equation 3.

Afterward, the apparatus may determine the ratio of the discretization value of the N-th channel and the discretization value of the (N+1)-th channel as the representative discretization value of the N-th channel based on a case that a discretization value of the N-th channel of the individual pixel or the target pixel 505, and a discretization value of the (N+1)-th channel of the individual pixel or the target pixel 505 following the N-th channel are determined.

A method in which the apparatus determines the representative discretization value may be expressed by

Equation 4 below.

$$mid = \frac{{B}_{N} + {B}_{N + 1}}{2} \qquad [ Equation 4 ]$$

Here, mid may denote a representative discretization value; B_{N} may denote a discretization value of the N-th channel; and, B_{N+1} may denote a discretization value of the (N+1)-th channel.

Accordingly, referring to the representative discretization values in the table 515, the apparatus may determine that the first representative discretization value is 0.340476, based on a discretization value of 0.01 at the first channel and a discretization value of 0.6709524 at the second channel. Furthermore, the apparatus may determine representative discretization values of a plurality of channels according to Equation 4.

The apparatus may set a probability value of each channel based on a case that the representative discretization values of channels are determined. For example, the apparatus may set a probability value that matches the representative discretization value corresponding to each channel.

In detail, in a situation where the target pixel 505 includes an estimation depth corresponding to 5.2 m, which is the depth of the actual object, the apparatus may set a probability value, which matches the representative discretization value, while increasing or decreasing the probability value by 0.05 from 0 to 1. For example, to obtain the probability distribution of an estimation depth corresponding to a depth of 5.2 m, the apparatus may set the representative discretization value (e.g., 4.667619) of channel 4 and the representative discretization value (e.g., 7.236905) of channel 5, which are closest to 5.2 m, as a region of interest. The apparatus may increase or decrease the probability value, which matches the representative discretization value corresponding to two channels included in the region of interest, by 0.05 from 0 to 1.

In more detail, the apparatus may sequentially set probability values of 1, 0.95, 0.9, 0.85, and 0.8 as a probability value matching the representative discretization value (e.g., 4.667619) of channel 4. Correspondingly, the apparatus may sequentially set (i.e., the second condition that the sum may be 1) probability values of 0, 0.05, 0.1, 0.15, and 0.2 as a probability value matching the representative discretization value (e.g., 7.236905) of channel 5. In summary, the representative discretization value (e.g., 4.667619) of channel 4 and the representative discretization value (e.g., 7.236905) of channel 5 may follow a first distribution (1, 0), a second distribution (0.95, 0.05), a third distribution (0.9, 0.1), a fourth distribution (0.85, 0.15), and a fifth distribution (0.8, 0.2).

However, the method of setting the probability value is not limited thereto. For example, to obtain the probability distribution of an estimation depth corresponding to a depth of 5.2 m, the apparatus may increase or decrease probability values of three channels, for example, the representative discretization value (e.g., 4.667619) of channel 4, which is closest to 5.2 m, the representative discretization value (e.g., 7.236905) of channel 5, and the representative discretization value (e.g., 10.37714) of channel 6 by 0.05 from 0 to 1.

Next, the apparatus may determine the obtained expectation value as the estimation depth of the target pixel 505 by obtaining the expectation value of each of the first to fifth distributions.

The method in which the apparatus obtains the expectation value of the distribution may be expressed by Equation 5 below.

$$E ( x ) = {\sum }_{i = 1}^{K} {P}_{i} \times \frac{{B}_{i} + {B}_{i + 1}}{2} \qquad [ Equation 5 ]$$

Here, E(x) may denote an expectation value; Pᵢ may denote a probability value matching the i-th representative discretization value; and,

$$\frac{{B}_{i} + {B}_{i + 1}}{2}$$

may denote the i-th representative discretization value.

For example, according to Equation 5, the apparatus may obtain “4.667619”, which is the result of “4.667619×1+7.236905×0” as the expectation value of the first distribution. According to equation 5, the apparatus may obtain “4.796083”, which is the result of “4.667619×0.95+7.236905×0.05” as the expectation value of the second distribution. According to equation 5, the apparatus may obtain “4.924548”, which is the result of “4.667619×0.9+7.236905×0.1” as the expectation value of the third distribution. According to equation 5, the apparatus may obtain “5.053012”, which is the result of “4.667619×0.85+7.236905×0.15” as the expectation value of the fourth distribution. According to equation 5, the apparatus may obtain “5.181476”, which is the result of “4.667619×0.8+7.236905×0.2” as the expectation value of the fifth distribution.

Here, referring to the fifth distribution, the expectation value 540 of the fifth distribution may be 5.181476, and may indicate the closest value as the estimation depth corresponding to 5.2 m, which is the depth of the actual object at the target pixel 505. Accordingly, the apparatus may set the fifth distribution to a target distribution 530, and may determine the target distribution 530 as the probability distribution of the estimation depth included in the target pixel 505.

As described above, the apparatus may not only determine the probability distribution of the target pixel 505, but also determine the probability distribution of each pixel different from the target pixel 505. If the probability distribution of pixels (e.g., some or all) included in the depth tensor 500 is determined, the apparatus may determine the depth tensor 500 described above as a depth estimation map.

FIG. 6 shows an example of a process of training a monocular depth estimation model by obtaining a first loss function and a second loss function in a training apparatus, according to an example of the present disclosure.

An apparatus (e.g., the apparatus 100 in FIG. 1) may obtain pose conversion information 607 by applying an input image 601 of time point t′ and an input image 603 of time point t to a pose estimation model 605. The apparatus may obtain a depth estimation map 611 by applying the input image 603 of time point t to a monocular depth estimation model 609.

The apparatus may obtain a first cluster of points (e.g., a first point cloud 613), which is a 3D point cloud at time point t, by applying the inverse of an intrinsic parameter corresponding to a specific image sensor (e.g., a lidar or a camera) to a depth estimation map 611. Afterward, the apparatus may obtain a second cluster of points (e.g., a second point cloud 615), which is a 3D point cloud of time point t′, by applying the pose conversion information 607 to the first point cloud 613. Moreover, the apparatus may convert the second point cloud 615 of time point t′ into 2D image coordinates by applying the intrinsic parameter to the second point cloud 615. Furthermore, the apparatus may create a reconstruction image 617 based on pixels of the input image 603 at time point t corresponding to the 2D image coordinates.

The apparatus may convert a 3D point cloud of time point t corresponding to location (10, 20) of the depth estimation map 611 into a 3D point cloud of time point t′ based on the pose conversion information 607. Besides, the apparatus may convert the 3D point cloud of time point t′ corresponding to location (10, 20) of the depth estimation map 611 into 2D image coordinates (e.g., (15, 18)) based on the intrinsic parameter. Moreover, the apparatus may generate the reconstruction image 617 by assigning a pixel value (e.g., 218) of the input image 603 corresponding to the 2D image coordinates (15, 18) of time point t′ to (10, 20).

The apparatus may determine a first loss function based on the depth estimation map 611 and a depth distribution map 619, and may determine a second loss function based on the reconstruction image 617 and the input image 603 of time point t.

The apparatus may obtain a first estimation depth of the first pixel among a plurality of pixels included in the depth distribution map 619 and may obtain a second estimation depth of the second pixel, which is related to a location corresponding to the first pixel, from among a plurality of pixels included in the depth estimation map 611. For reference, the estimation depth may indicate the expectation value of the probability distribution corresponding to the corresponding pixel. The apparatus may determine the first loss function based on a difference between the first estimation depth and the second estimation depth. Afterward, the apparatus may update a plurality of weights included in the monocular depth estimation model 609 for obtaining the second estimation depth based on the first loss function thus determined.

However, the method of determining the first loss function is not limited thereto. For example, if the first estimation depth satisfies a predetermined third condition, the apparatus may determine a difference between the first estimation depth and the second estimation depth as the first loss function. If the first estimation depth does not satisfy the third condition, the apparatus may skip updating at least one weight included in the monocular depth estimation model for obtaining the second estimation depth. In detail, the third condition may indicate a condition that the estimation depth is not 0, and the first loss function may be expressed by Equation 6 and Equation 7 below.

$${depth}_{mask} = ( {estimated}_{depth} > 0 ? 1 : 0 ) \qquad [ Equation 6 ]$$

Here, depthₘₐₛₖ may denote a mask for adjusting the training of the monocular depth estimation model 609 depending on a value of a first estimation depth. estimated_{depth}, may denote the first estimation depth.

That is, depthₘₐₛₖ may include ‘1’ if the first estimation depth is greater than ‘0’, and may include ‘0’ in other cases.

$$Loss = avg [ - log \{ 1 - abs ( ( {E}_{d 1} \times {depth}_{mask} ) - ( {E}_{d 2} \times {depth}_{mask} ) ) \} ] \qquad [ Equation 7 ]$$

Here, Loss may denote a first loss function; E_{d1} may denote a first estimation depth; E_{d2} may denote a second estimation depth; and, depth mask may be the same as that described in Equation 6.

In summary, if the first estimation depth is greater than ‘0’, the first loss function may be determined based on the difference between the first estimation depth and the second estimation depth. If the first estimation depth is smaller than or equal to ‘0’, the first loss function may be ‘0’. In other words, if the first estimation depth is smaller than or equal to ‘0’, the apparatus determines the first loss function to be ‘0’. The apparatus may skip updating the plurality of weights included in the monocular depth estimation model for obtaining the second estimation depth.

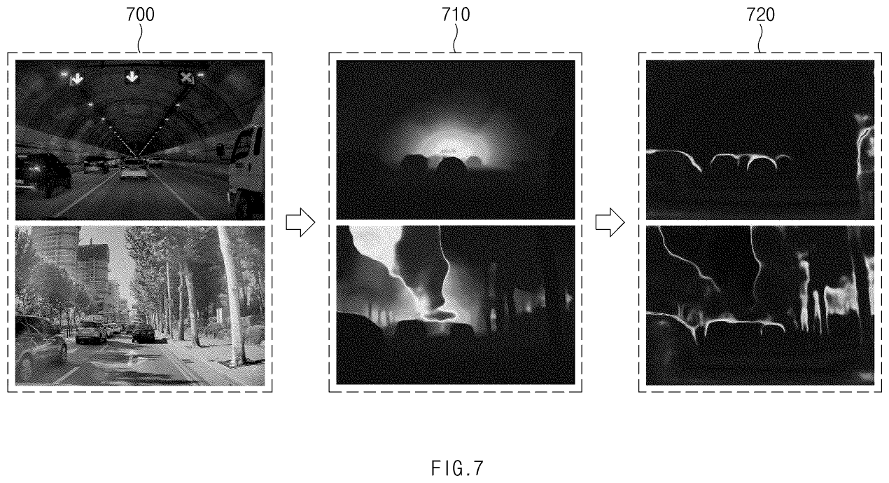

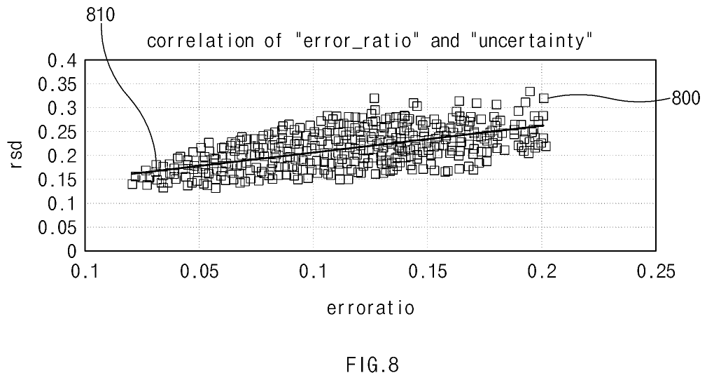

Through the above example, the apparatus may train the monocular depth estimation model 609 by applying a loss function group including the first loss function and the second loss function to the monocular depth estimation model 609. The apparatus may obtain RSD indicating the uncertainty of a target pixel, by obtaining a first factor indicating the mean of channels of the target pixel among pixels included in the depth estimation map 611, and a second factor indicating the standard deviation of the channels of the target pixel. Detailed descriptions related to the RSD are described later in FIGS. 7 and 8 below.

FIG. 7 shows an example of a target image, an estimation depth of each of pixels included in an input image, and uncertainty of each of the pixels included in the input image in an inference apparatus, according to an example of the present disclosure.

An inference apparatus according to an example may include a processor and a memory including instructions. For example, the inference apparatus may indicate an inference apparatus that uses a monocular depth estimation model trained by a training apparatus (e.g., the training apparatus 100 in FIG. 1).

The inference apparatus may obtain a target image 700 for testing. The inference apparatus may obtain a target depth estimation map 710 including the estimation depth of each of a plurality of pixels included in the target image, by applying the target image 700 to a monocular depth estimation model (i.e., a monocular depth estimation model trained by a training apparatus) including updated weights. The inference apparatus may obtain a target uncertainty map 720 including RSD of each of a plurality of estimation depths included in the target depth estimation map 710.

For example, the inference apparatus may obtain a first factor indicating the mean of channels of the target pixel among pixels included in the target depth estimation map 710, and a second factor indicating the standard deviation of the channels of the target pixel. The inference apparatus may obtain the RSD, which indicates the uncertainty of the target pixel, based on the first factor and the second factor.

The RSD according to an example may be expressed by Equation 8 below.

$${RSD}_{h , w} = \frac{{δ}_{h , w}}{{μ}_{h , w}} \qquad [ Equation 8 ]$$

Here, (h,w) may denote coordinates indicating a location of the target pixel; μ_{h,w} may denote the first factor; μ_{h,w} may denote the second factor; and, RSD_{h,w} may denote the RSD.

FIG. 8 shows an example of a correlation between an estimation depth and RSD in a training apparatus, according to an example of the present disclosure.

Referring to FIG. 8, a horizontal axis of a graph may mean an error ratio of the trained monocular depth estimation model, and a vertical axis of the graph may mean RSD. For example, an area 800 shown in a graph may include the error ratio and RSD of each of a plurality of pixels in the depth estimation map obtained from the trained monocular depth estimation model.

Next, a straight line 810 shown in the graph may be a straight line indicating the correlation between the error ratio and the RSD in the area 800. That is, the straight line 810 may include a relationship in which the error ratio increases as the RSD indicating uncertainty increases. The correlation corresponding to the straight line 810 may be expressed by Equation 9 below.

$${error}_{ratio} = max ( \frac{{depth}_{pred}}{{real}_{depth}} , \frac{{real}_{depth}}{{depth}_{pred}} ) ∝ {Uncertainty}_{h , w} \qquad [ Equation 9 ]$$

Here,

$${error}_{ratio} = max ( \frac{{depth}_{pred}}{{real}_{depth}} , \frac{{real}_{depth}}{{depth}_{pred}} )$$

may denote an error ratio, which is the horizontal axis of the graph. In particular, it may refer to the error ratio obtained based on the estimated depth and actual depth of each of a plurality of pixels included in the depth estimation map. Uncertainty_{h,w} may denote the RSD indicating the uncertainty of target pixel (h, w).

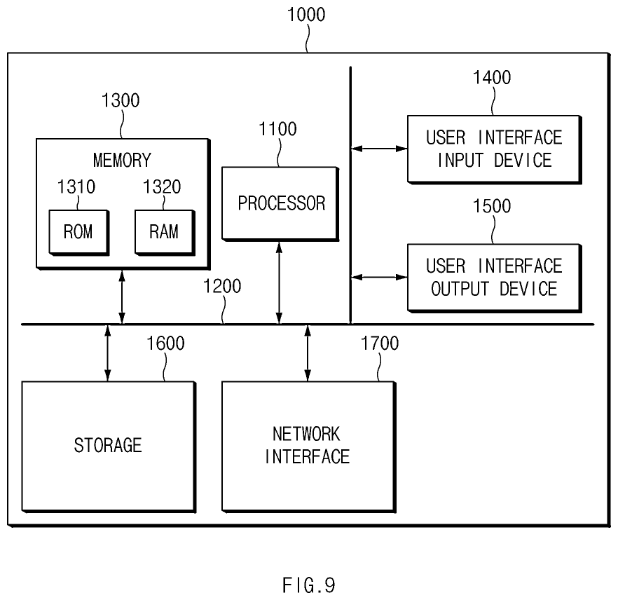

FIG. 9 shows an example of a computing system related to a training apparatus or training method, according to an example of the present disclosure.

Referring to FIG. 9, a computing system 1000 related to a training apparatus or a training method may include at least 1300, a user interface input one processor 1100, a memory device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively or additionally, the storage medium may be integrated with the processor 1100. The processor and storage medium may be implemented with an application specific integrated circuit (ASIC). The ASIC may be provided in a user terminal. Alternatively or additionally, the processor and storage medium may be implemented with separate components in the user terminal.

The present disclosure was made to solve the above-mentioned problems occurring in the prior art while advantages achieved by the prior art are maintained intact.

An example of the present disclosure provides a training apparatus that may obtain a pixel estimation depth by using only a monocular depth estimation model without an image generation model for obtaining a complex model structure, a loss function, and a disparity for self-supervised-based depth estimation, by obtaining a depth distribution map based on a depth map obtained from a point cloud, an inference apparatus and a training method.

Moreover, an example of the present disclosure provides a training apparatus that may estimate uncertainty while maintaining the depth estimation performance of the monocular depth estimation model, by obtaining a first loss function based on a depth distribution map and a depth estimation map and a second loss function based on images classified by using a plurality of time points, an inference apparatus and a training method.

Furthermore, an example of the present disclosure provides a training apparatus that may obtain a valid correlation between an estimation depth and a relative standard deviation (RSD) of each of the plurality of pixels included in a target depth estimation map by obtaining the RSD indicating the estimation depth and uncertainty of each of the plurality of pixels included in the target depth estimation map, an inference apparatus and a training method.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a training apparatus may include a memory that stores computer-executable instructions, and at least one processor that executes the instructions by accessing the memory. The at least one processor may obtain a depth distribution map based on a depth map obtained from a point cloud of a target time point, may obtain a depth estimation map by applying an input image of the target time point to a monocular depth estimation (MDE) model, and may update a plurality of weights included in the MDE model by applying a loss function group including a first loss function obtained based on the depth distribution map and the depth estimation map to the MDE model.

In an example, the at least one processor may obtain the depth map by extracting pieces of depth information from the point cloud, may obtain a depth tensor by extending a channel of the depth map by a predetermined first condition by using the pieces of depth information of each of a plurality of pixels based on the plurality of pixels included in the depth map, and may obtain the depth distribution map based on the depth tensor.

In an example, the at least one processor may determine a min discretization value and a max discretization value based on a sensor (e.g., a light detection and ranging (lidar) sensor) to determine a discretization value of each of channels included in an individual pixel of the depth tensor, and may determine the discretization value of each of the channels included in the individual pixel, based on an index of each of the channels included in the individual pixel, the min discretization value, the max discretization value, and the number of the channels.

In an example, the at least one processor may determine a ratio of a discretization value of an N-th channel and a discretization value of an (N+1)-th channel as a representative discretization value of the N-th channel based on a case that the discretization value of the N-th channel of the individual pixel and the discretization value of the (N+1)-th channel of the individual pixel following the N-th channel are determined. The N-th channel may be a channel regarding a natural number of ‘N’ that is smaller than or equal to the number of channels of the depth tensor.

In an example, the depth distribution map may include pixels, for each of which a representative discretization value corresponding to channels included in each of pixels of the depth tensor is determined. A sum of probabilities corresponding to channels included in each of the pixels of the depth tensor may include probabilities that satisfy a predetermined second condition.

In an example, the at least one processor may obtain a first estimation depth of a first pixel among a plurality of pixels included in the depth distribution map, may obtain a second estimation depth of a second pixel, which is related to a location corresponding to the first pixel, from among a plurality of pixels included in the depth estimation map, may determine the first loss function based on the first estimation depth and the second estimation depth, and may update the plurality of weights included in the MDE model for obtaining the second estimation depth based on the determined first loss function.

In an example, the at least one processor may determine a difference between the first estimation depth and the second estimation depth as the first loss function if the first estimation depth satisfies a predetermined third condition, and may skip updating the plurality of weights included in the MDE model for obtaining the second estimation depth if the first estimation depth does not satisfy the third condition.

In an example, the at least one processor may obtain pose change information by applying an input image of a time point different from the target time point, and an input image of the target time point to a pose estimation model, may obtain a first point cloud of the target time point by applying an inverse of an intrinsic parameter related to a lidar to the depth estimation map, may obtain a second point cloud of a time point different from the target time point by applying the pose change information to the first point cloud, and may determine a second loss function different from the first loss function based on the second point cloud. The loss function group may further include the second loss function.

In an example, the at least one processor may obtain a reconstruction image by applying the intrinsic parameter to the second point cloud, and may determine the second loss function based on the input image and the reconstruction image.

In an example, the at least one processor may obtain a first factor indicating a mean of channels of a target pixel among pixels included in the depth estimation map, and a second factor indicating a standard deviation of the channels of the target pixel, and may obtain a relative standard deviation (RSD), which indicates uncertainty of the target pixel, based on the first factor and the second factor.

According to an example of the present disclosure, an inference apparatus using an MDE model trained by the training apparatus may include a memory configured to store instructions capable of being executed by a computer, and at least one processor configured to execute the instructions by accessing the memory. The at least one processor may obtain a target image for testing, may obtain a target depth estimation map including an estimation depth of each of a plurality of pixels included in the target image, by applying the target image to an MDE model including updated weights, and may obtain a target uncertainty map including an RSD of each of a plurality of estimation depths included in the target depth estimation map.

According to an example of the present disclosure, a training method may include obtaining a depth distribution map based on a depth map obtained from a point cloud of a target time point, obtaining a depth estimation map by applying an input image of the target time point to an MDE model, and updating a plurality of weights included in the MDE model by applying a loss function group including a first loss function obtained based on the depth distribution map and the depth estimation map to the MDE model.

In an example, the obtaining of the depth distribution map may include obtaining the depth map by extracting pieces of depth information from the point cloud, obtaining a depth tensor by extending a channel of the depth map by a predetermined first condition by using the pieces of depth information of each of a plurality of pixels based on the plurality of pixels included in the depth map, and obtaining the depth distribution map based on the depth tensor.

In an example, the obtaining of the depth distribution map may include determining a min discretization value and a max discretization value based on a lidar to determine a discretization value of each of channels included in an individual pixel of the depth tensor, and determining the discretization value of each of the channels included in the individual pixel, based on an index of each of the channels included in the individual pixel, the min discretization value, the max discretization value, and the number of the channels.

In an example, the obtaining of the depth distribution map may include determining a ratio of a discretization value of an N-th channel and a discretization value of an (N+1)-th channel as a representative discretization value of the N-th channel based on a case that the discretization value of the N-th channel of the individual pixel and the discretization value of the (N+1)-th channel of the individual pixel following the N-th channel are determined. The N-th channel may be a channel regarding a natural number of ‘N’ that is smaller than or equal to the number of channels of the depth tensor. The depth distribution map may include pixels, for each of which a representative discretization value corresponding to channels included in each of pixels of the depth tensor is determined. A sum of probabilities corresponding to channels included in each of the pixels of the depth tensor may include probabilities that satisfy a predetermined second condition.

In an example, the updating of the plurality of weights included in the MDE model may include obtaining a first estimation depth of a first pixel among a plurality of pixels included in the depth distribution map, obtaining a second estimation depth of a second pixel, which is related to a location corresponding to the first pixel, from among a plurality of pixels included in the depth estimation map, determining the first loss function based on the first estimation depth and the second estimation depth, and updating the plurality of weights included in the MDE model for obtaining the second estimation depth based on the determined first loss function.

In an example, the updating of the plurality of weights included in the MDE model may include determining a difference between the first estimation depth and the second estimation depth as the first loss function if the first estimation depth satisfies a predetermined third condition, and skipping updating the plurality of weights included in the MDE model for obtaining the second estimation depth if the first estimation depth does not satisfy the third condition.

In an example, the training method may further include obtaining pose change information by applying an input image of a time point different from the target time point, and an input image of the target time point to a pose estimation model, obtaining a first point cloud of the target time point by applying an inverse of an intrinsic parameter related to a lidar to the depth estimation map, obtaining a second point cloud of a time point different from the target time point by applying the pose change information to the first point cloud, and determining a second loss function different from the first loss function based on the second point cloud. The loss function group may further include the second loss function.

In an example, the determining of the second loss function may include obtaining a reconstruction image by applying the intrinsic parameter to the second point cloud, and determining the second loss function based on the input image and the reconstruction image.

In an example, the training method may further include obtaining a first factor indicating a mean of channels of a target pixel among pixels included in the depth estimation map, and a second factor indicating a standard deviation of the channels of the target pixel, and obtaining an RSD, which indicates uncertainty of the target pixel, based on the first factor and the second factor.

The above description is merely an example of the technical idea of the present disclosure, and various modifications and modifications may be made by one skilled in the art without departing from the essential characteristic of the present disclosure.

The above-described examples may be implemented with hardware elements, software elements, and/or a combination of hardware elements and software elements. For example, the devices, methods, and components described in examples of the present disclosure may be implemented by using general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing device may perform an operating system (OS) or a software application running on the OS. Further, the processing device may access, store, manipulate, process and generate data in response to execution of software. It will be understood by those skilled in the art that although a single processing device may be shown for convenience of understanding, the processing device may include a plurality of processing elements and/or a plurality of types of processing elements. For example, the processing device may include a plurality of processors or one processor and one controller. Also, the processing device may include a different processing configuration, such as a parallel processor.

Software may include computer programs, codes, instructions or one or more combinations thereof and configure a processing device to operate in a desired manner or independently or collectively control the processing device. Software and/or data may be permanently or temporarily embodied in any type of machine, components, physical equipment, virtual equipment, computer storage media or devices or transmitted signal waves so as to be interpreted by the processing device or to provide instructions or data to the processing device. Software may be dispersed throughout computer systems connected via networks and be stored or executed in a dispersion manner. Software and data may be recorded in a computer-readable storage medium.

The methods according to the above-described examples may be recorded in a computer-readable medium including program instructions that are executable through various computer devices. The computer-readable medium may also include program instructions, data files, data structures, or a combination thereof. The program instructions recorded in the medium may be designed and configured specially for the examples of the present disclosure or may be known and available to those skilled in computer software. The computer-readable medium may include hardware devices, which are specially configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of computer programs include not only machine language codes created by a compiler, but also high-level language codes that are capable of being executed by a computer by using an interpreter or the like.

The hardware device described above may be configured to act as one or more software modules to perform the operations of the above-described examples of the present disclosure, or vice versa.

Even though the examples are described with reference to restricted drawings, it may be obviously to one skilled in the art that the examples are variously changed or modified based on the above description. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other examples, and equivalents to claims are within the scope of the following claims.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

Descriptions of a training apparatus, an inference apparatus, and a training method according to an example of the present disclosure, and a method therefor are as follows.

According to at least one of examples of the present disclosure, it is possible to obtain a pixel estimation depth by using only a monocular depth estimation model without an image generation model for obtaining a complex model structure, a loss function, and a disparity for self-supervised-based depth estimation, by obtaining a depth distribution map based on a depth map obtained from a point cloud.

Moreover, according to at least one of examples of the present disclosure, it is possible to estimate uncertainty while maintaining the depth estimation performance of the monocular depth estimation model, by obtaining a first loss function based on a depth distribution map and a depth estimation map and a second loss function based on images classified by using a plurality of time points.

Furthermore, according to at least one of examples of the present disclosure, it is possible to obtain a valid correlation between an estimation depth and a relative standard deviation (RSD) of each of the plurality of pixels included in a target depth estimation map by obtaining the RSD indicating the estimation depth and uncertainty of each of the plurality of pixels included in the target depth estimation map.

Besides, a variety of effects directly or indirectly understood through the specification may be provided.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus comprising:
at least one processor; and
a memory storing instructions, when executed by the at least one processor, cause the apparatus to:
obtain, based on a depth map obtained from a cluster of points at a target time point, a depth distribution map;
obtain, based on an input image that is associated with the target time point and that is applied to a monocular depth estimation (MDE) model, a depth estimation map;
update, based on a loss function group applied to the MDE model, a plurality of weights included in the MDE model, wherein the loss function group comprises a first loss function that is obtained based on the depth distribution map and the depth estimation map; and
output a signal indicating the updated plurality of weights.

2. The apparatus of claim 1, wherein the instructions, when executed by the at least one processor, further cause the apparatus to:
obtain the depth map by extracting pieces of depth information from the cluster of points, wherein the pieces of depth information are associated with a plurality of pixels included in the depth map;
obtain a depth tensor by extending a channel of the depth map, wherein the channel of the depth map is extended by a first condition based on the pieces of depth information; and
obtain, based on the depth tensor, the depth distribution map.

3. The apparatus of claim 2, wherein the instructions, when executed by the at least one processor, further cause the apparatus to:
determine, based on sensing information obtained by a sensor, a minimum discretization value and a maximum discretization value that are associated with channels included in an individual pixel of the depth tensor; and
determine a discretization value of each of the channels, wherein the discretization value of each of the channels is determined based on an index of each of the channels included in the individual pixel, the minimum discretization value, the maximum discretization value, and a number of the channels.

4. The apparatus of claim 3, wherein the instructions, when executed by the at least one processor, further cause the apparatus to:
determine, based on a discretization value of an N-th channel of an individual pixel of the depth tensor and a discretization value of an (N+1)-th channel of the individual pixel following the N-th channel, a ratio of the discretization value of the N-th channel and the discretization value of the (N+1)-th channel as a representative discretization value of the N-th channel, and
wherein N is a natural number and smaller than or equal to a total number of channels of the depth tensor.

5. The apparatus of claim 4, wherein depth distribution map comprises pixels, and wherein a representative discretization value of a pixel of the pixels is associated with channels included in the pixel of pixels of the depth tensor, and
wherein a sum of probabilities comprises probabilities that satisfy a second condition, wherein the sum of probabilities is associated with channels included in each of the pixels of the depth tensor.

6. The apparatus of claim 1, wherein the instructions, when executed by the at least one processor, further cause the apparatus to:
obtain a first estimation depth of a first pixel among a plurality of pixels included in the depth distribution map;
obtain a second estimation depth of a second pixel among a plurality of pixels included in the depth estimation map, wherein the second pixel is related to a location corresponding to the first pixel;
determine, based on the first estimation depth and the second estimation depth, the first loss function; and
update, based on the determined first loss function, the plurality of weights included in the MDE model for obtaining the second estimation depth.

7. The apparatus of claim 6, wherein the instructions, when executed by the at least one processor, further cause the apparatus to:
determine, based on the first estimation depth satisfying a third condition, a difference between the first estimation depth and the second estimation depth as the first loss function; or
skip updating, based on the first estimation depth not satisfying the third condition, the plurality of weights included in the MDE model for obtaining the second estimation depth.

8. The apparatus of claim 1, wherein the instructions, when executed by the at least one processor, further cause the apparatus to:
obtain pose change information by applying an input image at a time point different from the target time point and an input image at the target time point to a pose estimation model;
obtain a first cluster of points at the target time point by applying an inverse of an intrinsic parameter related to a sensor to the depth estimation map;
obtain a second cluster of points at a time point different from the target time point by applying the pose change information to the first cluster of points; and
determine, based on the second cluster of points, a second loss function different from the first loss function, and
wherein the loss function group further comprises the second loss function.

9. The apparatus of claim 8, wherein the instructions, when executed by the at least one processor, further cause the apparatus to:
obtain a reconstruction image by applying the intrinsic parameter to the second cluster of points; and
determine, based on the input image and the reconstruction image, the second loss function.

10. The apparatus of claim 8, wherein the instructions, when executed by the at least one processor, further cause the apparatus to:
obtain a first factor indicating a mean value associated with channels of a target pixel among pixels included in the depth estimation map and a second factor indicating a standard deviation value associated with the channels of the target pixel; and
obtain, based on the first factor and the second factor, a relative standard deviation value indicating uncertainty of the target pixel.

11. An apparatus comprising:
at least one processor; and
a memory storing instructions, when executed by the at least one processor, cause the apparatus to:
obtain a target image for testing;
obtain a target depth estimation map by applying the target image to a monocular depth estimation model including updated weights, wherein target depth estimation map comprises an estimation depth of each of a plurality of pixels included in the target image;
obtain a target uncertainty map, wherein the target uncertainty map comprises a relative standard deviation value of each of a plurality of estimation depths included in the target depth estimation map; and
output a signal indicating the target uncertainty map.

12. A method performed by a processor, the method comprising:
obtaining, based on a depth map obtained from a cluster of points at a target time point, a depth distribution map;
obtaining a depth estimation map by applying an input image that is associated with the target time point to a monocular depth estimation (MDE) model;
updating, based on a loss function group applied to the MDE model, a plurality of weights included in the MDE model, wherein the loss function group comprises a first loss function that is obtained based on the depth distribution map and the depth estimation map; and
outputting a signal indicating the updated plurality of weights.

13. The method of claim 12, wherein the obtaining the depth distribution map comprises:
obtaining the depth map by extracting pieces of depth information from the cluster of points, wherein the pieces of depth information are associated with a plurality of pixels included in the depth map;
obtaining a depth tensor by extending a channel of the depth map, wherein the channel of the depth map is extended by a first condition based on the pieces of depth information; and
obtaining, based on the depth tensor, the depth distribution map.

14. The method of claim 13, wherein the obtaining the depth distribution map comprises:
determining, based on sensing information obtained by a sensor, a minimum discretization value and a maximum discretization value that are associated with channels included in an individual pixel of the depth tensor; and
determining a discretization value of each of the channels, wherein the discretization value of each of the channels is determined based on an index of each of the channels included in the individual pixel, the minimum discretization value, the maximum discretization value, and a number of the channels.

15. The method of claim 14, wherein the obtaining the depth distribution map comprises:
determining, based on a discretization value of an N-th channel of an individual pixel and a discretization value of an (N+1)-th channel of the individual pixel following the N-th channel, a ratio of the discretization value of the N-th channel and the discretization value of the (N+1)-th channel as a representative discretization value of the N-th channel, and
wherein N is a natural number and smaller than or equal to a total number of channels of the depth tensor,
wherein the depth distribution map comprises pixels, and wherein a representative discretization value of a pixel of the pixels is associated with channels included in the pixel of pixels of the depth tensor, and
wherein a sum of probabilities comprises probabilities that satisfy a second condition, wherein the sum of probabilities is associated with channels included in each of the pixels of the depth tensor.

16. The method of claim 12, wherein the updating the plurality of weights included in the MDE model comprises:
obtaining a first estimation depth of a first pixel among a plurality of pixels included in the depth distribution map;
obtaining a second estimation depth of a second pixel among a plurality of pixels included in the depth estimation map, wherein the second pixel is related to a location corresponding to the first pixel;
determining, based on the first estimation depth and the second estimation depth, the first loss function; and
updating, based on the determined first loss function, the plurality of weights included in the MDE model for obtaining the second estimation depth.

17. The method of claim 16, wherein the updating the plurality of weights included in the MDE model comprises:
determining, based on the first estimation depth satisfying a third condition, a difference between the first estimation depth and the second estimation depth as the first loss function; or
skipping, based on the first estimation depth not satisfying the third condition, updating the plurality of weights included in the MDE model for obtaining the second estimation depth.

18. The method of claim 12, further comprising:
obtaining pose change information by applying an input image at a time point different from the target time point and an input image at the target time point to a pose estimation model;
obtaining a first cluster of points at the target time point by applying an inverse of an intrinsic parameter related to a sensor to the depth estimation map;
obtaining a second cluster of points at a time point different from the target time point by applying the pose change information to the first cluster of points; and
determining, based on the second cluster of points, a second loss function different from the first loss function, and
wherein the loss function group further comprises the second loss function.

19. The method of claim 18, wherein the determining the second loss function comprises:
obtaining a reconstruction image by applying the intrinsic parameter to the second cluster of points; and
determining, based on the input image and the reconstruction image, the second loss function.

20. The method of claim 18, further comprising:
obtaining a first factor indicating a mean value associated with channels of a target pixel among pixels included in the depth estimation map and a second factor indicating a standard deviation value associated with the channels of the target pixel; and
obtaining, based on the first factor and the second factor, a relative standard deviation value indicating uncertainty of the target pixel.
